(19) United States
(12) Patent Application Publication
(10) Pub. No.: US 2006/0213032 A1
(43) Pub. Date: Sep. 28, 2006

(54) Rotation limiting mechanism

(75) Inventors: Yung-Chi Yang, Taipei (TW); Yue-Jun Hu, Taipei (TW); Mike Cai, Taipei (TW); Li-Ming Le, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/087,493

(22) Filed: Mar. 22, 2005

(51) Int. Cl. E05D 11/08

(52) U.S. Cl. 16/340

(57) ABSTRACT

A rotation limiting mechanism is proposed for connecting a base and a pedestal body of a display. The base includes at least one supporting portion. The rotation limiting mechanism includes a fixing member and at least one rotation adjusting member. The fixing member can be connected to the base. The rotation adjusting member includes a pedestal body connecting portion for being connected to the pedestal body, a rotating portion pivoted on the fixing member, and a limiting portion for correspondingly limiting an angle of forward or backward tilt of the supporting portion. By such arrangement, a simplified structure can be provided.

### FIELD OF THE INVENTION

The present invention relates to rotation limiting mechanisms, and more particularly, to a rotation limiting mechanism for an electronic device.

### BACKGROUND OF THE INVENTION

As an electronic device e.g. a liquid crystal display (LCD) is provided with advantages such as light weight, miniaturized volume and no radiation, it has gradually replaced a conventional screen display. A common liquid crystal display is substantially supported by a base. In order to ensure stability of the liquid crystal display, the width of the base is usually far larger than that of the liquid crystal display, so as to prevent collapse of the liquid crystal display and damage to the liquid crystal panel due to the unstable center of gravity thereof when adjusting a visual angle of a screen of the liquid crystal display. Therefore, it usually requires a huge size of packing material to transport the liquid crystal display with such base, such that the number of liquid crystal displays that can be accommodated within a certain space is relatively reduced and a transportation cost is dramatically increased.

Accordingly, Taiwanese Patent No. 531019 has disclosed an improved base for a liquid crystal display. Referring to FIGS. 1A and 1B, the base of the liquid crystal display comprises two pedestal bodies 11 serving as supporting devices, and a rotation limiting mechanism comprising a reverse member 12, a shaft member 13 and a brake member 14.

Each of the pedestal bodies 11 is preferably a pedestal body having a vertical bending angle for providing a great supportive effect. The two pedestal bodies 11 are oppositely located to support the liquid crystal display (not shown). Further, a spindle hole 112 is formed through an upper portion of each of the pedestal bodies 11 so as to receive the shaft member 13. A limiting portion 113 is provided atop on each of the pedestal bodies 11, and a stopping block 1131 is protruded on each of a front side and a back side of the limiting portion 113.

The reverse member 12 of the rotation limiting mechanism comprises a first fixing portion 121 for fixing the liquid crystal display, and a second fixing portion 123 connected and located perpendicularly to the first fixing portion 121. Two sides of the second fixing portion 123 adjacent to the first fixing portion 121 are extended downwardly and provided with spindle holes 1231 for receiving the shaft member 13. An edge of the second fixing portion 123 adjacent to the first fixing portion 121 is extended horizontally and provided with a tenon 1233. The tenon 1233 can be engaged with the limiting portion 113, such that the second fixing portion 123 can be shifted between the stopping blocks 1131 on the front side and the back side of the limiting portion 113. Moreover, a rotating angle of the reverse member 12 is limited by means of each of the stopping blocks 1131 and a blocking piece 1132 located between each of the pedestal bodies 11 and the brake member 14. At least one hole 1235 is formed at a side of the spindle hole 1231 of the reverse member 12 so as to connect the reverse member 12 to the brake member 14 via the hole 1235. The shaft member 13 comprises a rod portion 131 and a connecting portion 133. The rod portion 131 allows the shaft member 13 to penetrate the spindle hole 112 and the brake member 14. The connecting portion 133 can be screwed to a packing member 134 so as to connect the reverse member 12 and each of the pedestal bodies 11 together. The brake member 14 comprises a fixing plate 141 and a fastening plate 142. The fixing plate 141 is formed with a blocking groove 1411 and a corresponding reverse groove 1412, and also formed with a protruding tenon 1413 at a position corresponding to the hole 1235, such that the fixing plate 141 and the reverse member 12 can be connected and driven together by coupling the protruding tenon 1413 to the hole 1235. A fastening tenon 1421 is located at an edge of the fastening plate 142, and is formed with a tenon groove 1422 on an inner side thereof to provide rotation flexibility.

When a user rotates the liquid crystal display, the reverse member 12 and the fixing plate 141 are synchronously rotated, and the fastening tenon 1421 is engaged with the reverse groove 1412. After continuously applying a force, the fastening tenon 1421 is released from the reverse groove 1412 and shifted along a surface of the fixing plate 141. Finally, when the fastening tenon 1421 approaches the blocking groove 1411, the fastening tenon 1421 is engaged with the blocking groove 1411 due to release of the force.

Although the foregoing patent provides visual angle adjustment to forwardly or backwardly tilt the liquid crystal display and reduces the packing size to thus decrease the transportation cost, the rotation limiting mechanism disclosed in the foregoing patent is structurally very complex, thereby increasing difficulty in assembly thereof. Further, as the rotation limiting mechanism is composed of various components, and in consideration of adaptability between the components, it requires more criteria in fabrication and a relatively higher fabrication cost.

Moreover, it is difficult to assure that the stopping blocks located on the front side and the back side of the limiting portion of the rotation limiting mechanism are coplanar during an assembling process, such that a rotating angle of the liquid crystal display is not easily controlled and may become too large or too small, thereby causing inconvenience in usage. Furthermore, if dimensional and positional errors of the components are significant, problems in alignment, positioning and fixation are caused and make the product defective.

Additionally, the stopping blocks located on the front side and the back side of the limiting portion and the tenon would be damaged due to long-term friction, and thus the accuracy of limiting the rotating angle is affected. As a result, not only the rotation limiting effect cannot be properly achieved, but also the liquid crystal display may fall down, become damaged or hurt the user due to the unsatisfactory rotation limiting effect.

Therefore, the problem to be solved here is to provide a rotation limiting mechanism with a simplified structure, which can eliminate the foregoing drawbacks in the prior art, and achieve the improvements such as simple assembly, appropriate rotation and satisfactory limitation of rotation, reduction in assembly cost, and decrease in defective products.

### SUMMARY OF THE INVENTION

In light of the above prior-art drawbacks, a primary objective of the present invention is to provide a rotation limiting mechanism that is simplified in structure.

Another objective of the present invention is to provide a rotation limiting mechanism that can be easily assembled.

Still another objective of the present invention is to provide a rotation limiting mechanism for reducing a fabrication cost.

A further objective of the present invention is to provide a rotation limiting mechanism for achieving appropriate rotation and accurate limitation of rotation.

A further objective of the present invention is to provide a rotation limiting mechanism for improving a production yield and reducing defective products.

In accordance with the above and other objectives, the present invention proposes a rotation limiting mechanism applied to a display at least having a base and a supporting portion. The rotation limiting mechanism comprises a fixing member and at least one rotation adjusting member. The fixing member is connected to the base. The rotation adjusting member comprises a pedestal body connecting portion for being connected to a pedestal body, a rotating portion pivoted on the fixing member, and a limiting portion for correspondingly limiting an angle of forward or backward tilt of the supporting portion.

Preferably, the rotating portion is a revolving axle. When two or more rotation adjusting members are employed, the rotating portions of the rotation adjusting members can be coaxially or non-coaxially arranged. The limiting portion can be a structure extended from a periphery of the rotating portion and having a notch, wherein the notch has an acute angle. Preferably, the limiting portion comprises a pair of tenons. In an embodiment, the limiting portion can be provided on the periphery of the rotating portion.

Unlike the prior art using only a shaft member of a base to rotate a display and thus making structure of the conventional rotation limiting mechanism complicated, the rotation limiting mechanism proposed in the present invention can be mounted behind the base of the display, such that the limiting portion of the rotation limiting mechanism can be coordinated with any supportable position in the base. Thus, after other components of the display such as a display module, panel, casing and so on are assembled with the base, a rotating angle of the rotating portion in the rotation limiting mechanism can be controlled so as to limit rotation of the display within a certain range of angles by means of the limiting portion.

Therefore, the rotation limiting mechanism in the present invention can eliminate the prior-art drawbacks such as a complex structure, difficulty in assembly, a higher fabrication cost, an inappropriate rotating angle (too large or too small) of the display, an unsatisfactory rotation limiting effect, a low production yield, fall and damage of the display and even hurting a user thereby, and so on. The present invention allows structure of the rotation limiting mechanism to be simplified, such that significant improvements can be achieved such as easy assembly, appropriate rotation and satisfactory limitation of rotation, reduction in assembly cost, and decrease in defective products.

### BRIEF DESCRIPTION OF THE DRAWINGS

The present invention can be more fully understood by reading the following detailed description of the preferred embodiments, with reference made to the accompanying drawings, wherein:

FIG. 1A (PRIOR ART) is an exploded view showing a conventional rotation limiting mechanism for a base of a liquid crystal display;

FIG. 1B (PRIOR ART) is a schematic diagram showing the rotation limiting mechanism in FIG. 1A after assembly;

FIG. 2 is an exploded view of a rotation limiting mechanism and a base according to a preferred embodiment of the present invention;

FIG. 3 is a schematic diagram showing the rotation limiting mechanism and the base in FIG. 2 after assembly;

FIG. 4A is a partial schematic diagram showing an operating status of the assembled rotation limiting mechanism and base in FIG. 3 according to the preferred embodiment of the present invention;

FIG. 4B is a partial schematic diagram showing another operating status of the assembled rotation limiting mechanism and base in FIG. 3 according to the preferred embodiment of the present invention; and

FIG. 5 is a schematic diagram showing an operating status of the rotation limiting mechanism according to the present invention assembled to a display.

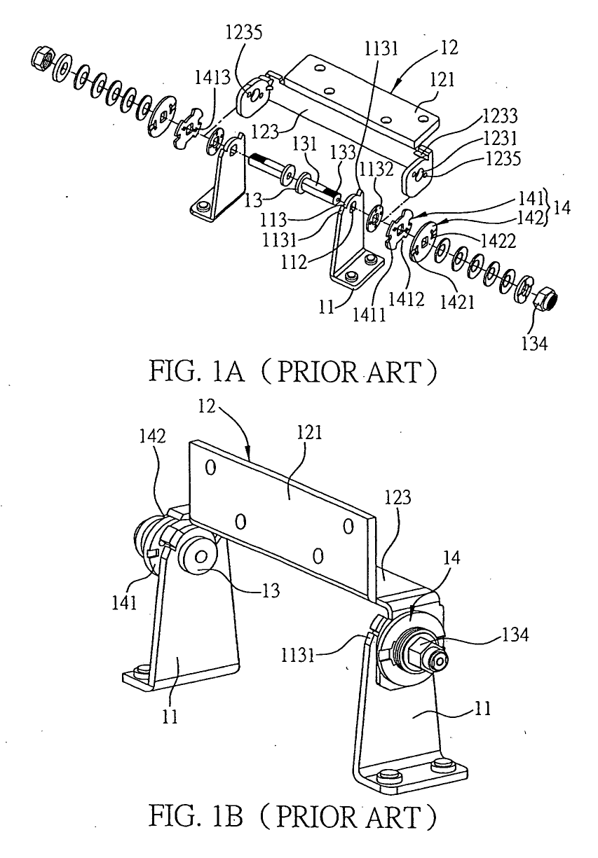

### DETAILED DESCRIPTION OF THE PREFERRED EMBODIMENTS

The following preferred embodiments are used to provide detailed description for the present invention but not for limiting the scope of the invention.

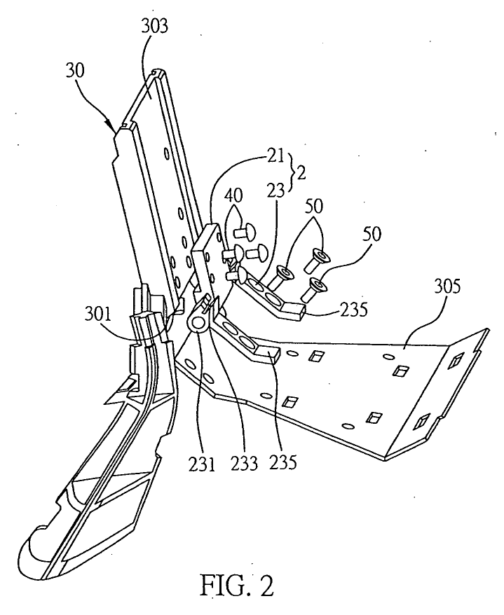

FIGS. 2 to 5 are schematic diagrams showing the preferred embodiments of the present invention. A rotation limiting mechanism 2 proposed in the present invention is applied to a display at least having a base and a supporting portion. In the following embodiments, the display can be, but is not limited to, a liquid crystal display or a display of a panel computer. As any conventional display is suitable for the present invention and would not be structurally modified in the present invention, in order to simplify the description and clarify the technical features and structures of the present invention, only the structures directly relating to the present invention are shown in the drawings.

Referring to FIG. 2, the rotation limiting mechanism 2 is applied to the display at least having a base 30 and a supporting portion 301. The rotation limiting mechanism 2 comprises a fixing member 21 and at least one rotation adjusting member 23. The fixing member 21 is connected to the base 30. The rotation adjusting member 23 comprises a rotating portion 231 pivoted on the fixing member 21, and a limiting portion 233 located at a position corresponding to the supporting portion 301. In order to simplify the drawing, only the base 30 and the supporting portion 301 of the display are shown in FIG. 2. As adjustment of a visual angle by rotation of the display primarily refers to adjustment of a rotating angle of a screen of the display, such action would be simplified as adjusting an angle of forward or backward tilt of the display in the following description.

In this embodiment, the fixing member 21 can be optionally connected to a display connecting portion 303 of the base 30. For example, a fastening element 40 such as a screw can be used to connect the fixing member 21 and the display connecting portion 303 together. It should be noted that in this embodiment the fixing member 21 is a rectangular structure located at a position substantially corresponding to the display connecting portion 303 and having a surface area smaller than that of the display connecting portion 303; however, any structure that can be connected to the display connecting portion 303 without affecting assembly of other components of the display can serve as the fixing member 21 for the present invention.

The rotating portion 231 of the at least one rotation adjusting member 23 can be a revolving axle. In the case of a plurality of the rotation adjusting members 23 being used, the rotating portions 231 thereof can be coaxially or non-coaxially arranged. The limiting portion 233 of the at least one rotation adjusting member 23 can be a structure extended from a periphery of the rotating portion 231 and having a notch, wherein for example the limiting portion 233 comprises a pair of tenons, and the notch has an acute angle. In this embodiment, there are two rotation adjusting members 23 pivoted on two sides of the fixing member 21, but such arrangement does not set a limitation in the present invention; it is understood that the number and location of the rotation adjusting members 23 can be modified in other embodiments. The rotation adjusting member 23 can further comprise a pedestal body connecting portion 235 that can be connected to a pedestal body 305 of the base 30 by means of a fastening element 50 such as a screw. It is understood by a person having ordinary knowledge in the art that structures of the pedestal body 305 and the pedestal body connecting portion 235 are not limited by the description of this embodiment and can be modified depending on practical requirements.

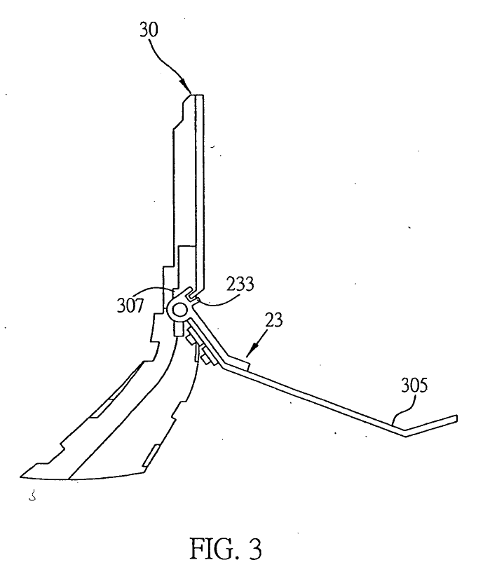

When the fixing member 21 is connected to the display connecting portion 303, the limiting portion 233 is located at a position corresponding to the supporting portion 301, and the pedestal body connecting portion 235 is connected to the pedestal body 305, the rotation limiting mechanism 2 can thus be mounted to the base 30 as shown in FIG. 3.

Referring to FIG. 3, as the rotating portion 231 of the rotation adjusting member 23 is pivoted on the base 30, the pedestal body 305 of the base 30 can be shifted to actuate rotation of the rotating portion 231, such that the limiting portion 233 can partly abut against the supporting portion 301. Therefore, rotation of the rotating portion 231 can be actuated by shifting the pedestal body 305, and it is free to forwardly or backwardly tilt the display with respect to the limiting portion 233 as described later. Moreover, a friction force applied to the rotation adjusting member 23 can be dispersed by connecting the fixing member 21 to the base 30 during the forward or backward tilt of the display.

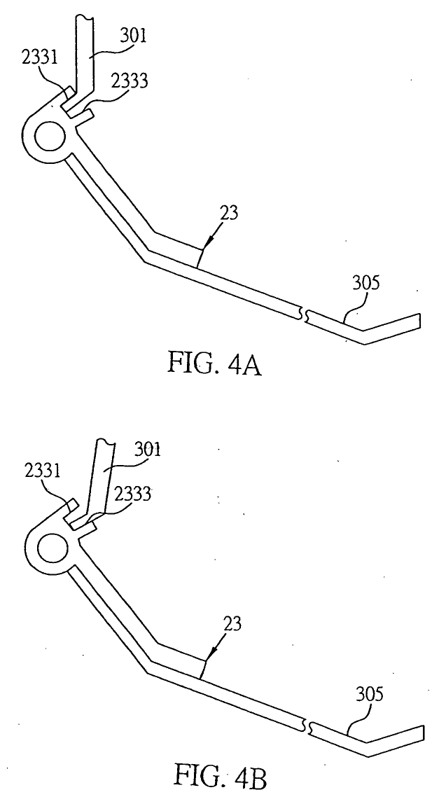

Referring to FIG. 4A, when the pedestal body 305 is shifted in a direction toward the rotation adjusting member 23, a first inner surface 2331 of the limiting portion 233 abuts against the supporting portion 301 whereas a second inner surface 2333 of the limiting portion 233 is not in contact with the supporting portion 301. Referring to FIG. 4B, when the pedestal body 305 is shifted in a direction away from the rotation adjusting member 23, the second inner surface 2333 of the limiting portion 233 abuts against the supporting portion 301 whereas the first inner surface 2331 of the limiting portion 233 is not in contact with the supporting portion 301.

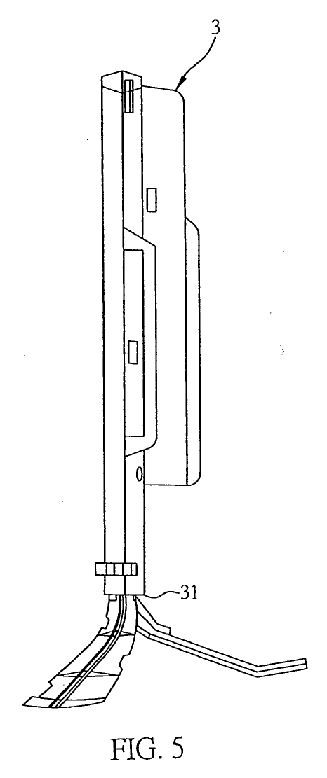

Referring to FIGS. 3 and 5, after assembling other components of the display 3, as the limiting portion 233 is located at the periphery of the rotating portion 231, a rotating angle of the rotating portion 231 is limited by means of the limiting portion 233 up to an angle reaching at least one blocking portion 307 (only one is shown) of the base 30 and/or any position within a casing of the display 3. In other words, the limiting portion 233 is capable of limiting the tilting angle of the display 3 within an appropriate angle range. Therefore, the prior-art drawback of an inappropriate rotating angle (too large or too small) of the display can be eliminated.

Accordingly, the rotation limiting mechanism 2 in the present invention can shift the pedestal body 305 to optionally move the supporting portion 301 of the base 30 within the limiting portions 233 of the rotation adjusting members 23, so as to provide a most preferable adjustment effect of the visual angle by forward or backward tilt. Generally, the most preferable visual angle is for example an angle between −5 degrees and 20 degrees using a vertical line as reference.

Furthermore, apart from the base 30, the supporting portion 301 can also be provided at any other positions of the display 3 or of the base 30. This embodiment only serves as a demonstrative example, and such modifications of the present invention may be easily accomplished and performed by the person having ordinary knowledge in the art.

Therefore, unlike the conventional complicated structure, the rotation limiting mechanism in the present invention is structurally simplified, easily assembled and capable of reducing a fabrication cost. Moreover, the limiting portion formed as an extended structure located at the periphery of the rotating portion can achieve appropriate rotation and accurate limitation of rotation, such that the prior-art drawback such as structural damage can be eliminated and defective products can be reduced to improve a production yield.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A rotation limiting mechanism for connecting a base and a pedestal body of a display, the base having at least one supporting portion, the rotation limiting mechanism comprising:
a fixing member for being connected to the base; and
at least one rotation adjusting member comprising a pedestal body connecting portion for being connected to the pedestal body, a rotating portion pivoted on the fixing member, and a limiting portion for correspondingly limiting a tilting angle of the supporting portion.

2. The rotation limiting mechanism of claim 1, wherein the rotating portion is a revolving axle.

3. The rotation limiting mechanism of claim 1, wherein a plurality of the rotation adjusting members are provided.

4. The rotation limiting mechanism of claim 3, wherein the rotating portions of the rotation adjusting members are coaxially arranged.

5. The rotation limiting mechanism of claim 3, wherein the rotating portions of the rotation adjusting members are free from being coaxially arranged.

6. The rotation limiting mechanism of claim 1, wherein the limiting portion is a structure extended from a periphery of the rotating portion and having a notch.

7. The rotation limiting mechanism of claim 6, wherein the notch has an acute angle.

8. The rotation limiting mechanism of claim 1, wherein the limiting portion comprises a pair of tenons.

9. The rotation limiting mechanism of claim 1, wherein the limiting portion is located at a periphery of the rotating portion.
